(19) United States
(12) Patent Application Publication
(10) Pub. No.: US 2014/0130407 A1
(43) Pub. Date: May 15, 2014

(54) CONTAINER COVER DEVICE, SYSTEM, AND METHOD

(71) Applicants: Raquel Langford, Mount Dora, FL (US); Dustin Martin, Mount Dora, FL (US)

(72) Inventors: Raquel Langford, Mount Dora, FL (US); Dustin Martin, Mount Dora, FL (US)

(21) Appl. No.: 13/677,935

(22) Filed: Nov. 15, 2012

(51) Int. Cl. A01G 13/02

(52) U.S. Cl. CPC A01G 13/02
USPC 47/31.1; 47/32.3

(57) ABSTRACT

A container cover device including a pliable sheet comprising a perimeter configured to be secured to an upper portion of a container so as to prevent spillage of contents of the container if the container were tilted, said pliable sheet having a first side and a second side, an opening provided in the pliable sheet extending from the first side to the second side of the pliable sheet, and a slit extending from the opening to the perimeter, thereby defining a first end and a second end of the container cover device, wherein the first end and the second end are configured to be removably engageable with one another, wherein the container cover device inhibits and/or prevents vegetative growth around an object configured to extend through the opening in the container cover device. A system and method are also disclosed.

### FIELD OF THE INVENTION

The present invention relates generally to a container used to house a plant and, more specifically, to a device that prevents unwanted vegetative growth in a container around an object or potted plant. The device further protects contents of the container from interference by external factors.

### BACKGROUND OF THE INVENTION

Pot or container grown, plants, flowers and trees are often grown for sale, transplanting or experimentation by commercial landscape nurseries. The containers they are grown in vary in size and are typically filled with but not limited to a combination of materials including soils, fertilizers, chemicals, herbicides, pesticides, or anything supplementary to the desired product to aid in growth, for example. The supplementary plant nutrients help to provide an ideal environment for plant growth and proliferation. The plant containers are used to collect water essential for the plant's survival and to reduce evaporation of the water from the plant. Containers are further used to protect the soil and the plant from external environmental factors which can retard or prevent plant growth such as varying weather conditions or adverse environmental factors.

### BRIEF DESCRIPTION OF THE INVENTION

In one embodiment, a container cover device is provided including a pliable sheet including a perimeter configured to be secured to an upper portion of a container so as to prevent spillage of contents of the container if the container were tilted, the pliable sheet having a first side and a second side. An opening is provided in the pliable sheet extending from the first side to the second side of the pliable sheet, and a slit extending from the opening to the perimeter, thereby defining a first end and a second end of the container cover device, wherein the first end and the second end are configured to be removably engageable with one another, wherein the container cover device inhibits and/or prevents vegetative growth around an object configured to extend through the opening in the container cover device.

In another embodiment, a system is provided for preventing vegetation growth around a base of a potted plant, tree or object. The system includes a pliable sheet including a perimeter configured to engage an upper portion of a container, the pliable sheet having a first side and a second side. An opening in the pliable sheet extending from the first side to the second side of the pliable sheet and a slit extending from the opening to the perimeter, thereby defining a first end and a second end of the pliable sheet is provided, wherein the first side of one of the first or second ends is configured to overlap the second side of the other of the first or second end such that the first end can be removably engaged to the second end for placement and securement around the base of the plant, tree or object. The system is further provided wherein the pliable sheet can be removably secured to the upper portion of the container such that the opening provides a passageway for the plant or tree to pass through, and wherein the pliable sheet inhibits vegetation growth around the base of the plant or tree.

In yet another embodiment, a method for preventing unwanted vegetative growth is provided. The method includes providing a container cover device with a pliable top sheet with an opening through which an object may extend and a perimeter configured to be secured taut to a container when secured to the container, separating the pliable top sheet along a slit extending from an edge of the sheet to the opening. The method further includes passing the object through the separated slit until the object is within the opening, positioning the device at a top of a container with the perimeter placed around an upper portion of the container; and closing the slit to secure the device to the container.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 provides a perspective view of a second side of an embodiment of a pot cover device;

FIG. 2 provides a perspective view of an embodiment of the pot cover device secured to an upper portion of a pot;

FIG. 3 provides rows of containers housing plants as shown in a nursery, wherein container cover devices are provided thereon; and

FIG. 4 provides a diagram illustrating a method of preventing vegetative growth around a potted plant or tree.

### DETAILED DESCRIPTION OF THE INVENTION

For the purposes of promoting an understanding of the principles and operation of the invention, reference will now be made to the embodiments illustrated in the drawings and specific language will be used to describe the same. It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding of the invention as disclosed and claimed herein, the following definitions are provided.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. It is to be noted that all ranges disclosed within this specification are inclusive and are independently combinable.

The term “taut” as used herein, for example, with reference to an “elastic component surrounding at least a portion of the opening is configured to fit taut around a portion of a plant” includes the elastic component is stretched or pulled tightly around a portion of the plant, without slack in the elastic component, such that the elastic component is tense around the portion of the plant with which it is in contact, so as to avoid creating a space at the junction between the elastic component and the portion of the plant extending through the opening.

The term “pliable” as used herein includes flexible, movable, easily bent or shaped or molded, a component which can take different shapes. A pliable component includes but is not limited to a flexible component.

The term “securement” as used herein includes but is not limited to the process of securing. For example, securement may include attaching or affixing the device around the upper portion of a container as described herein.

The term “container” as used herein includes pots and/or cans used to grow trees, plants, flowers, and other live organisms. Thus this term generally includes any housing that can be used to house a tree, plant, flower, or other live organism, for example.

The term “object” as used herein, includes living organisms including but not limited to those belonging to the Plantae kingdom such as herbs, bushes, grasses, vines, ferns, mosses, plants, flowers, perennials, annuals, shrubs, groundcovers, uprights, trees, or any other similar living organism known in the art. “Object” also refers to structural features such as poles, fences, apparatus for watering, and other non-living structures which may be, for example, surrounded by soil, fertilizer or other materials which allow the growth of organisms around the object or to assist with growth of the object. In some embodiments, the object may be housed within a pot or other container. Alternatively, the object may be located in the ground. Thus, as used herein the term object shall not be considered limiting as it is a relevant term to use with respect to living organisms and inanimate elements.

The term “material” as used herein includes but is not limited to soil, fertilizer, additives, nutrients, supplements, a chemical which aids in the growth of the contents of the container including plants, trees, flowers and other desireable vegetation. Material, furthermore, may refer to pesticides or chemicals used to remove or reduce the growth of undesireable weeds, organisms, algae, bacteria and other pests within the container or area surrounding the object to further the desireable growth within the container.

The inventors have found that growth of unwanted vegetation in potted plants is an ongoing problem, particularly in plant nursery production. The soil within the container often provides optimal conditions for undesirable weed growth, organisms, algae, bacteria and pests which interfere with the conditions and growth of the potted plant. Weeds, algae, and bacteria not only reduce the amount of sunlight reaching the desired plants within the container, slowing their growth rate, but also absorb essential nutrients in the soil that are critical to plant development. Pests and undesirable organisms also hinder plant and tree growth and proliferation in potted plants and trees.

Physically removing weeds as they sprout is highly labor intensive and inefficient. Consequently, many growers have resorted to the use of costly chemical herbicides for controlling weed growth in their planting containers. Samples of air, soil, and water taken from locations remote from nurseries which have utilized chemical herbicides over time have included trace amounts of such herbicides. Although the herbicides employed in the United States have been subjected to stringent regulatory testing and approval, the long-term effects on humans, animals, and the environment are, as yet, unknown. Limiting exposure to such toxic chemicals is crucial, and any reduction in the amount of these chemicals leaching from the area of their intended use would be highly beneficial. Moreover, reducing the chemicals used to exterminate unwanted organisms, bacteria, algae, plant growths, etc. will be beneficial to the environment and to the users of the device.

Additionally, plant containers are often knocked over unexpectedly by external factors, wind, pets, or children, wherein the soil, fertilizer and other materials escape from the container. In these cases, spillage of fertilizer can result in contamination of ground soil and groundwater supply with nitrate leeching out from the container. Containment of fertilizer provides a great benefit allowing the original quantity of fertilizer in a container to provide the desired effect on the growth of the contents of the container. Therefore, the inventors have discovered a device and method for preventing undesirable vegetative growth, organisms, algae, bacteria, and pests in a plant container and protecting the spillage of plants, soil, fertilizer, or other material contained within the container, while also allowing air circulation, watering, and growth of the plant.

The present invention relates to a device that inhibits and/or prevents unwanted vegetation growth within the contents of a container comprising, but not limited to, plants, flowers, perennials, annuals, shrubs, groundcovers, uprights, trees, or any other similar structure known in the art. The present invention further relates to a device which can be used to surround the base of a structure in the ground and prevent unwanted vegetative growth around the structure. The present invention further relates to a device used to prevent pets, children, algae, bacterial, organisms, and undesirable or harmful pests from contacting the material within the container, which may include plant soil, for example. The device serves to maintain only the material desired and needed within the container to allow the contents of the container to proliferate, and by preventing any unwanted interferences, examples which are described above, from contacting and/or interfering with the contents of the container.

In one embodiment, a container cover device disclosed herein is a container cover device, which may be reusable, and which may be provided to accommodate any sized container known to one of skill in the art. The container cover device may be provided in various shapes and sizes to accommodate various shaped and sized containers. The container cover device includes a pliable sheet including a perimeter configured to be secured to an upper portion of a container. In some embodiments the container cover device can be secured to a container which includes a rim around its upper portion, wherein the cover device can be secured around the rim of the container. However, in other embodiments the container cover device may be secured to a container without a rim around its upper portion. The pliable sheet of the container cover device includes a first side and a second side, an opening extending from the first side to the second side of the pliable sheet, and a slit extending from the opening to the perimeter of the pliable sheet, defining a first end and a second end of the container cover device. The first and second ends are configured to be removably engageable with one another. The slit of the container cover device provides easy application, placement, and removal of the container cover device from the container. In many cases, the container cover device may be placed onto the container before the container is placed in a nursery field, and the first and second ends of the container cover device can thereafter adhered together with the use of Velcro®, in one example, to ensure the overlapping of the ends of the container cover device is maintained.

In an embodiment, at least a portion of the perimeter includes an elastic component to secure the container cover device on the upper portion of the container so as to removably affix the container cover device onto the upper portion of the container, preventing soil and other materials within the container from being expelled from the container in windy outdoor weather conditions or in cases in which the container is knocked over onto its side. While in one embodiment of the container cover device, a portion of the perimeter may comprise an elastic component, in other embodiments, the entire perimeter may comprise an elastic component to enable the container cover device to more easily slide over the top of a potted plant and to provide for adjustability depending on the varying size of the container.

The first and second ends of the container cover device can be adjoined to one another along the length of the slit or at least a portion of the slit by at least one fastener structure. Various types of fastener structures may be used, for example, to fasten the first and second ends to one another. Some examples of fastener structures include but are not limited to Velcro®, tape, hook and eye, button and button hole, snap, tongue and groove, or Zipper®, or any combination of fastener structures known to those skilled in the art. The tongue and groove fastener structure includes at least one tongue provided on one of the first and second ends and at least one groove provided on the other of the first and second ends, wherein the tongue is lockingly receivable within the groove providing a fastening or attachment means between the first and second ends.

In another embodiment, the container cover device is provided wherein the first side of one of the first or second ends is configured to overlap at least a portion of the second side of the other of the first or second end such that the first end is removably engaged to the second end. In a preferred embodiment, at least a portion of the perimeter includes an elastic component to secure the container cover device on the container.

In yet another embodiment, the container cover device may further include an elastic component surrounding at least a portion of the opening in the pliable sheet, such that when an object, such as, but not limited to, a plant or tree, extends through the opening, a contact between the elastic component of the opening and the portion of the plant or tree extending there through can be made. In a further embodiment, a full or partial seal can be formed between the base of the object, and a portion of the pliable sheet surrounding the opening. In one example, the elastic component surrounding at least a portion of the opening is configured to fit taut around a portion of a plant or a tree extending through the opening and wherein the perimeter is configured to fit taut around a top portion of a container so as to inhibit and/or prevent vegetation growth around the plant or tree. The opening can be made to accommodate any size of plant trunk or base, allowing the plant to grow without injuring the plant or stunting its growth. In an exemplary embodiment, the container cover devices will be sized to accommodate a range of 3 inch pot containers up to a 30 gallon pot containers, which are the sizes most often used in plant nursery production. The container cover device is not required to be used in plant nurseries, but may also be provided for at home use, or any other use known by one skilled in the art. The container cover device can be installed around the base of an existing object, plant or tree in a container or may be installed on the container prior to plant or tree growth.

In one embodiment, the pliable sheet includes, in part or in whole, a semi-permeable component, wherein the pliable sheet is permeable to the passage of fluid, such as water, however the pliable sheet is impermeable to solid matter. The semi-permeable component prevents unwanted vegetative growth around the plant or object; however, it provides a healthy growth environment for the plant itself. The semi-permeable component, in one embodiment, may be ultraviolet resistant, durable, permeable to water, and fibrous, so as to prevent any plant or other growth, pests, and/or fertilizer from passing through the component. However, the semi-permeable component is permeable to sunlight as required to maintain optimal quality of the desired contents of the container, i.e., the plant or tree.

In another embodiment, a system for preventing vegetation growth around a base of a potted plant or tree is provided. The system includes a pliable sheet including a perimeter configured to engage an upper portion of a container, the pliable sheet having a first side and a second side. In a preferred embodiment, the perimeter contacts an outer surface of the upper portion of the container. The system further includes an opening in the pliable sheet extending from the first side to the second side of the pliable sheet. The opening is configured to provide a passageway for a growing plant or tree to extend there through. The pliable sheet further includes a slit extending from the opening to the perimeter, thereby defining a first end and a second end of the container cover device, wherein the first side of one of the first or second ends is configured to overlap the second side of the other of the first or second end such that the first end can be removably engaged to the second end for placement and securement of the container cover device around the base of the plant or tree. The system further includes wherein the pliable sheet can be removably secured to the upper portion of the container, the opening allowing the plant or tree to pass through, and wherein the pliable sheet inhibits vegetation growth around the base of the potted plant or tree. In a further embodiment, the first side of one of the first or second end is configured to at least partially overlap the second side of the other of the first or second end such that the first end is removably engaged to the second end. In a further embodiment, the first and second ends may be adjoined to one another by a fastener structure. Examples of fastener structures that may be used herein are as described above.

In another embodiment, either a portion or the entire perimeter of the pliable sheet includes an elastic component used to secure the container cover device onto the upper portion of the container to keep the container cover device on the container, and also sustain soil, fertilizer, as well as other plant materials within the container. Other materials may include additives or nutrients which are supplements incorporated with or added to the soil to aid in plant growth. The perimeter may be configured to fit taut around the top portion of the container to inhibit and/or prevent vegetation growth around the plant or tree and to prevent access to the container contents from unwanted interferences such as fungi, bacteria, human or animal interference, wind, and any other unwanted interferences known to one skilled in the art. In a further embodiment, the opening of the container cover device may be surrounded, at least in part, by an elastic component such that the opening is configured to fit taut around a portion of the plant or a tree extending through the opening. The pliable sheet may include in part or in whole a semi-permeable component, as described above, whereby the pliable sheet is permeable to fluid and impermeable to solid matter.

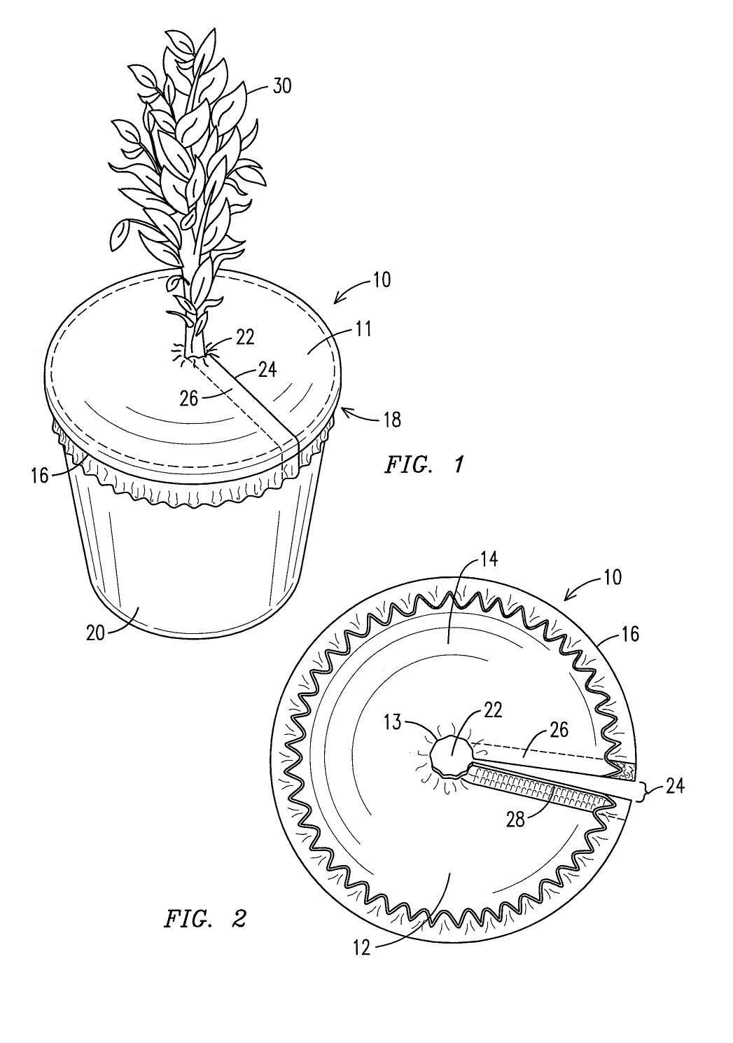

FIG. 1 provides a perspective view of the container cover device 10 disposed on a container 20 housing an object 30, the container cover device 10 including a pliable sheet 14. The container cover device 10 having a first side 11 and a second side 12 (not shown in FIG. 1) and a perimeter 16 secured to an upper portion 18 of the container 20. The pliable sheet 14 includes an opening 22 which extends from the first side 11 to the second side 12 of the device 10, and a slit 24 which extends from the opening 22 to the perimeter 16 which defines a first end 26 and a second end 28 of the container cover device 10. As can be seen in FIG. 1, the pliable sheet 14 of the container cover device 10 does not provide a downward slope from the opening 22 to the perimeter 16 so as to prevent the fluid on the container cover device 10 from draining off of the container cover device 10. Instead, any fluid (i.e., water) permeates through the semi-permeable component of the pliable sheet 14 into the container 20. A slit 24 is shown in FIG. 1, which defines a first end 26 and a second end 28 (second end not shown in FIG. 1) of the container cover device 10, shown as in overlapping engagement with one another.

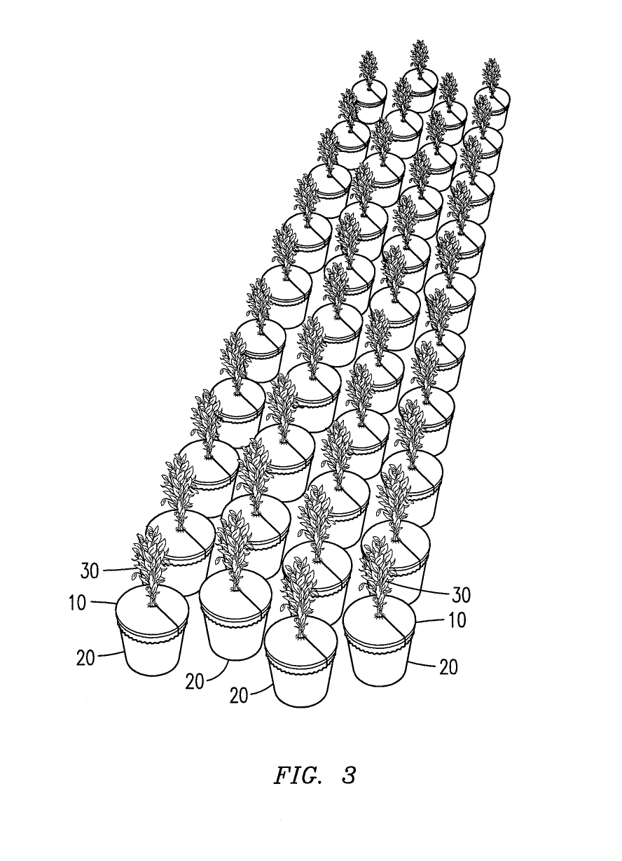

FIG. 2 provides a perspective view of a second side 12 of the container cover device 10. The pliable sheet 14 is shown including a perimeter 16, and the slit 24 being open wherein the first end 26 and the second end 28 are not attached to one another. The perimeter 16 is configured to be secured to the upper portion 18 of the container 20 and including an opening 22 provided in the pliable sheet extending from the first side 11 (not shown in FIG. 2) to the second side 12 of the pliable sheet 14. A slit 24 extending from the opening 22 of the pliable sheet 14 to the perimeter 16 defines a first end 26 and a second end 28 of the container cover device 10, configured to be in overlapping engagement with one another. The embodiment of FIG. 2 also provides an elastic component 13 shown along the opening 22 of the device 10. FIG. 3 provides a view of a series of containers 20 comprising plants in a production setting, wherein each container 20 includes a container cover device 10.

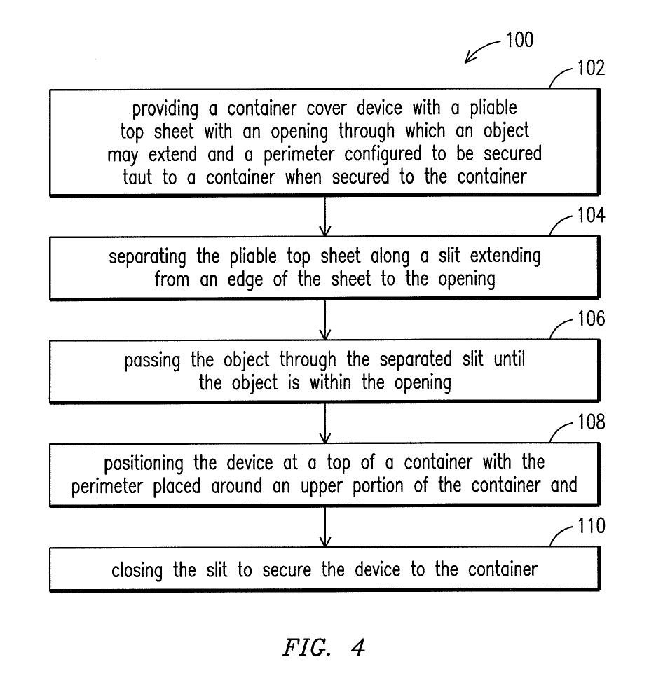

FIG. 4 provides a diagram illustrating a method 100 of preventing unwanted vegetative growth, the method including providing 102 a container cover device 10 with a pliable sheet 14 with an opening 22 through which an object 30 may extend and a perimeter 16 configured to be secured taut to a container 20 when secured to the container 20. The method further includes separating 104 the pliable sheet 14 along a slit 24 extending from an edge of the sheet 14 to the opening 22, passing 106 the object 30 through the separated slit 24 until the object 30 is within the opening 22, positioning 108 the device 10 at a top of the container 20 with the perimeter 16 placed around an upper portion of the container 20, and closing 110 the slit 24 to secure the device 10 to the container 20. The method further includes adjoining 112 a first end 26 and a second end 28 of the slit 24 to one another along a length of the slit 24 with a fastener structure 108.

In a further embodiment, the method 100 includes overlapping 114 the first side 11 of one of a first end or a second end 26, 28 with at least a portion of the second side 12 of the other of the first or second end 26, 28 such that the first end 26 is removably engaged to the second end 28.

In yet a further embodiment, the method 100 includes fitting 116 an elastic component 13 surrounding at least a portion of the opening taut around a portion of the object 30 extending through the opening 22, and fitting 118 the perimeter 16 taut around the upper portion of the container 20 so as to minimize unwanted vegetation growth around the object 30 and/or prevent spillage of material located within the container 20 if the container 20 were tilted.

It will nevertheless be understood that no limitation of the scope of the invention is thereby intended, such alterations and further modifications in the illustrated device, and such further applications of the principles of the invention as illustrated herein being contemplated as would normally occur to those skilled in the art to which the invention pertains. While a number of embodiments of the present invention have been shown and described herein in the present context, such embodiments are provided by way of example only, and not of limitation. Numerous variations, changes and substitutions will occur to those of skill in the art without materially departing from the invention herein. For example, the present invention need not be limited to best mode disclosed herein, since other applications can equally benefit from the teachings of the present invention. Accordingly, all such modifications are intended to be included within the scope of this invention as defined in the following claims, in accordance with relevant law as to their interpretation.

What is claimed is:

1. A container cover device comprising:
a pliable sheet comprising a perimeter configured to be secured to an upper portion of a container so as to prevent spillage of contents of the container if the container were tilted, said pliable sheet having a first side and a second side;
an opening provided in the pliable sheet extending from the first side to the second side of the pliable sheet;
a slit extending from the opening to the perimeter, thereby defining a first end and a second end of the container cover device, wherein the first end and the second end are configured to be removably engagable with one another, wherein the container cover device inhibits and/or prevents vegetative growth around an object configured to extend through the opening in the container cover device.

2. The container cover device of claim 1, wherein the first and second ends can be adjoined to one another along a length of the slit by at least one fastener structure.

3. The container cover device of claim 1, wherein the first side of one of the first or second end is configured to overlap at least a portion of the second side of the other of the first or second end such that the first end is removably engaged to the second end.

4. The container cover device of claim 2, wherein the at least one fastener structure comprises Velcro, tape, hook and eye, button and button hole, snap, tongue and groove, or Zipper, or any combination thereof.

5. The container cover device of claim 1, wherein at least a portion of the perimeter comprises an elastic component to secure the container cover device on the upper portion of the container.

6. The container cover device of claim 1, further comprising an elastic component surrounding at least a portion of the opening.

7. The container cover device of claim 6, wherein the elastic component surrounding at least a portion of the opening is configured to fit taut around a portion of an object extending through the opening and wherein the perimeter is configured to fit taut around a top portion of a container so as to inhibit and/or prevent vegetation growth around said object.

8. The container cover device of claim 1, wherein the pliable sheet comprises a semi-permeable component whereby the pliable sheet is permeable to fluid and impermeable to solid matter.

9. A system for preventing vegetation growth around a base of a potted plant, tree or object, said system comprising:
a pliable sheet comprising a perimeter configured to engage an upper portion of a container, said pliable sheet having a first side and a second side;
an opening in the pliable sheet extending from the first side to the second side of the pliable sheet and a slit extending from the opening to the perimeter, thereby defining a first end and a second end of the pliable sheet, wherein the first side of one of the first or second ends is configured to overlap the second side of the other of the first or second end such that the first end can be removably engaged to the second end for placement and securement around the base of the plant, tree or object;
wherein the pliable sheet can be removably secured to the upper portion of the container such that the opening provides a passageway for the plant or tree to pass through, and wherein the pliable sheet inhibits vegetation growth around the base of the plant or tree.

10. The system of claim 9, wherein the first and second ends can be adjoined to one another by a fastener structure.

11. The system of claim 9, wherein the first side of one of the first or second end is configured to overlap the second side of the other of the first or second end such that the first end is removably engaged to the second end.

12. The system of claim 10, wherein the fastener structure comprises Velcro®, tape, hook and eye, button and button hole, snap, tongue and groove, or Zipper®, or any combination thereof.

13. The system of claim 9, wherein at least a portion of the perimeter comprises an elastic component to secure the pliable sheet on the upper portion of the container, so as to sustain plant soil within the container.

14. The system of claim 9, further comprising an elastic component surrounding at least a portion of the opening.

15. The system of claim 14, wherein the elastic component surrounding at least a portion of the opening is configured to fit taut around a portion of a plant or a tree extending through the opening, and wherein the perimeter is configured to fit taut around a top portion of a container so as to inhibit and/or prevent vegetation growth around said plant or tree.

16. The system of claim 9, wherein the pliable sheet comprises a semi-permeable component whereby the pliable sheet is permeable to fluid and impermeable to solid matter.

17. A method for preventing unwanted vegetative growth, said method comprising:
providing a container cover device with a pliable top sheet with an opening through which an object may extend and a perimeter configured to be secured taut to a container when secured to the container;
separating the pliable top sheet along a slit extending from an edge of the sheet to the opening;
passing the object through the separated slit until the object is within the opening;
positioning the device at a top of a container with the perimeter placed around an upper portion of the container; and
closing the slit to secure the device to the container.

18. The method of claim 17, wherein closing the slit further comprises adjoining a first end and a second end of the slit to one another along a length of the slit with a fastener structure.

19. The method of claim 17, wherein closing the slit further comprises overlapping the first side of one of a first end or a second end with at least a portion of the second side of the other of the first or second end such that the first end is removably engaged to the second end.

20. The method of claim 17, further comprising fitting an elastic portion surrounding at least a portion of the opening taut around a portion of the object extending through the opening, and fitting the perimeter taut around the upper portion of the container so as to minimize vegetation growth around the object and/or prevent spillage of material located within the container if the container were tilted.
